(19) United States
(12) Patent Application Publication
(10) Pub. No.: US 2015/0046151 A1
(43) Pub. Date: Feb. 12, 2015

(54) SYSTEM AND METHOD FOR IDENTIFYING AND VISUALISING TOPICS AND THEMES IN COLLECTIONS OF DOCUMENTS

(71) Applicant: BAE Systems Australia Limited, Mawson Lakes (AU)

(72) Inventors: Aaron Lane, Prospect (AU); Rostyslav Buglak, Gleneg South (AU)

(21) Appl. No.: 14/387,268

(22) PCT Filed: Mar. 22, 2013
(86) PCT No.: PCT/AU2013/000284

§ 371 Date: Sep. 23, 2014

(30) Foreign Application Priority Data
Mar. 23, 2012 (AU) 2012901193

(51) Int. Cl. G06F 17/27; G06F 17/30

(52) U.S. Cl. CPC G06F 17/2785; G06F 17/30011
USPC 704/9

(57) ABSTRACT

Method and systems for estimating and visualising a plurality of topics in a collection of documents, wherein the collection of documents comprises a plurality of words and each document comprises one or more of the plurality of words, the method comprising: performing two rounds of topic modelling to the collection of documents, wherein the first round of topic modelling estimates a plurality of topics associated with the collection of documents and each topic comprises one or more words, and the second round identifies a plurality of themes associated with the topics, wherein each theme comprises one or more topics; and visually representing the topics and themes to a user.

### FIELD OF THE INVENTION

The present invention relates to natural language processing of collections of documents. In a particular form the present invention relates to tools for performing and visualising the results of topic modelling.

### BACKGROUND OF THE INVENTION

In recent years the capability of individuals or corporations to collect large collections of electronic documents has increased dramatically as the internet facilitates publication and sharing of documents and the cost of mass storage has decreased. Frequently individuals are interested in obtaining both a summary of the topics being discussed in a large collection of documents, as well as having the ability to drill down on specific topics of interest to identify further details such as the source of the document or the author. For example in a large corporation an IT manager may be interested in viewing the entire collection of email generated within the corporation to determine if email resources are being appropriately used, or to monitor sensitive topics to ensure confidential information is not inadvertently released. In another example an engineer in the corporation engaged in product development may be interested in studying the patent landscape or articles in technical journals related to a proposed product to establish freedom to operate or to identify new opportunities. In yet another example a marketing or public relations manager in the corporation may wish to study collections of documents obtained from media (including social media) to understand how the corporation is being viewed and discussed by a target audience.

The task of semantic analysis to summarise the content of multiple documents is a hard problem. Typically the documents in such collections are created by a large number of different authors, each of whom is free to choose what topics they discuss and the words they use to discuss a particular topic. Thus as the size of such collections grow, the word noise increases and it rapidly becomes difficult to determine what topics are being discussed and how individual documents are related.

Recently researchers in the fields of machine learning and natural language processing have begun developing what are known as topic models to address the problem of performing semantic analysis of a collection of documents through the use of topic models. Topic models are a type of statistical model for discovering the abstract “topics” that occur in a collection of documents based upon an underlying assumption that a specific topic discussed over several documents will typically include a set of related words. The difficulty is that a given document may include multiple documents and that one author may choose a different subset of the set of related words to another author, and the same words may be used for different topics. Topic models are typically hidden variable models in which one uses the observed data (the words in the documents) to infer the existence of hidden variables (topics). Topic models typically use Bayesian Statistical approaches to computationally analyse the collection of documents and for each topic produce a set of words associated with the topic along with some measure of association (e.g. a weighting or probability). When dealing with a large dataset, there may be a large number of topics present (e.g. 50 or more, each with its own list of associated words), and whilst they may be identified with a topic model, the sheer number of topics may be difficult for a user to comprehend and understand. In some cases the number of topics to be identified by the topic model can be limited to more manageable number (e.g. 10) however this risks oversimplifying the complexity of the collection.

Whilst there are many potential users of topic modelling, the complex statistical and computational nature of topic modelling limits the useability of topic modelling by those potential users. There is thus a need to provide improved tools for performing and visualising the output of topic modelling for users, or to at least provide a useful alternative to current systems.

### SUMMARY OF THE INVENTION

According to a first aspect of the present invention, there is provided a method for estimating a plurality of topics in a collection of documents, wherein the collection of documents includes a plurality of words and each document includes one or more of the plurality of words, the method comprising:

performing two rounds of topic modelling to the collection of documents, wherein the first round of topic modelling estimates a plurality of topics associated with the documents and each topic includes one or more words, and the second round identifies a plurality of themes associated with the topics, wherein each theme includes one or more topics; and

visually representing the topics and themes to a user.

In a further aspect in the step of visually representing the topics and themes to a user, each of the topics is represented by a topic identifier and each theme is represented by a theme border which encloses the representations of the topics associated with the theme to allow clear identification of which topics are associated with which themes.

In a further aspect each topic further comprises associating a topic identifier and a measure of topic association of each of the one or more words comprising the topic, and the first round of topic modelling also estimates a measure of document association of each topic with each document in the collection of documents, and the second round of topic modelling applies a topic model to a modified collection of documents wherein the words in each document in the collection of documents are replaced with one or more topic identifiers of topics based upon the measure of document association for the respective topics and each theme further comprises a theme identifier, one or more topic identifiers and a measure of theme association of each of the one or more topic identifiers with the theme.

In a further aspect the topic model applied is a Latent Dirichelet Allocation (LDA) topic model. The measures of topic or theme association may be probability, a weight, or an index based upon the probability. The number of themes and/or topics to be identified may be predefined or set by a user. The number of words per topic, or topics per theme may be fixed at a maximum, or a threshold may be used to limit the size of the list, or a combination of the two. The LDA model may be estimated using a Gibbs Sampling based approach.

In a further aspect visually representing the topics and themes to a user further comprises the steps of:

associating each topic with a zone, where each zone represents a distinct subset of one or more themes;

associating a zone location and zone border in a layout plane for each of the zones; creating a theme border for each theme wherein the theme border is based upon the zone borders of the zones associated with the respective theme;

displaying a representation of each theme border and each topic within the zone border of the associated zone.

In a further aspect associating a zone border further comprises creating an intersection graph of the zones in the layout plane and determining a zone border based upon nodes in the intersection graph. A user can interact with the displayed representations so as to adjust model input parameters and force reapplication of the topic models and redisplay of the output based upon the adjusted input parameters.

The above methods may be embodied in a computer usable medium which includes instructions for causing a computer to perform any of the methods described herein.

### BRIEF DESCRIPTION OF THE DRAWINGS

An illustrative embodiment of the present invention will be discussed with reference to the accompanying drawings wherein:

FIG. 1 is a schematic diagram of a collection of documents and generating topic and themes;

FIG. 2 is a flow chart 200 of the method for estimating topics and themes in a collection of documents according to an embodiment of the present invention;

FIG. 3 is a schematic diagram of the application of method illustrated in FIG. 2 to the collection of documents illustrated in FIG. 1; and

FIG. 4 is a schematic diagram 400 of a method for visually representing the topic and themes illustrated in FIG. 1 according to an embodiment of the present invention;

FIG. 5 is a representation of the output of the method illustrated in FIG. 4 according to an embodiment of the present invention;

FIG. 6 is a representation of the distinct subsets of topics in a layout plane according to an embodiment of the present invention;

FIG. 7 is a representation of a topic and topic collisions according to an embodiment of the present invention;

FIG. 8 is a representation of the topic identifiers and theme borders according to an embodiment of the present invention;

FIG. 9 is a representation of the output obtained after refitting the model in response to modification of the inputs by a user; and

FIG. 10 is representation of a computer system implementing a method according to an embodiment of the present invention.

In the following description, like reference characters designate like or corresponding parts or steps throughout the figures.

### DESCRIPTION OF ILLUSTRATIVE EMBODIMENT

In recent years, interest in the use of topic models for performing Latent semantic analysis of a collection of documents to identify hidden structure (topics) has grown. Topic models are typically based on the assumption that the documents in the collection are generated by a finite set of hidden topics (concepts), and attempt to identify these latent or hidden topics which capture the meaning of the observed text which is otherwise obscured by the word choice noise present in the documents. That is topic models provide a statistical approach for analysing a collection of documents to obtain estimates of topics, the words in each topic list, a measure of association (such as a probability or weight) of a word with a list (herein referred to as measure of word association), and a measure of association of a document with a topic (herein referred to as a measure of document association).

In particular one class of topic models known as Latent Dirichlet Allocation (LDA) has been favoured for performing Latent Semantic Analysis (Blei, Ng, and Jordan, Latent Dirichlet Allocation, Journal of Machine Learning Research 3 (2003) 993-1022; the entire contents of which is hereby incorporated by reference). LDA is a generative probabilistic model (and specifically a parametric empirical Bayes model) of a corpus in which the documents are modelled as random mixtures over latent topics where each topic is characterised by a distribution over words. That is LDA assumes that a plurality of topics are present or associated with a collection of documents, and that each document exhibits these topics with different proportions. Under an LDA model, documents may relate to a single topic or a mixture of topics (i.e. multiple topics) and a given word in the vocabulary may be associated with a mixture (i.e. multiple) different topics (typically with varying degrees of association). Based upon these assumptions and using the observed words in the documents, LDA estimates the posterior expectations of the hidden variables, namely the topic probability of a word, the topic proportions of a document and the topic assignment of a word. Whilst this embodiment is described using LDA it is to be appreciated that other topic models such as those based on other hidden variable models (probabilistic latent semantic analysis (pLSA), Markov Chain Monte Carlo (MCMC), etc), or variants of LDA may be used as required.

Each document in the collection of M documents includes a sequence of N words with the words being the basic units of discrete data. Thus the collection of documents includes a plurality of words (terms) which form a vocabulary of length V. Each document in the collection is a sequence of N words and can be represented as a vector w=(w₁, w₂, . . . , w_{N}) and the corpus of M documents may be represented by a vector D={w₁, w₂, . . . , w_{M}}. LDA assumes the words in the corpus are based upon or generated by a fixed number of topics K and estimates the word distribution φₖ for each topic k (i.e. which words are associated with the topic, and a measure of the association) and the topic distribution θ_{w} for each document w (i.e. which topics are associated with each document and a measure of the association).

For example table 1 lists three topics and associated measures of association from analysis of internal emails over a 3 month period from a (hypothetical) organisation that specialises in internet security products. The measures of association for each word in the table are the estimated probabilities obtained from fitting an LDA topic model to the corpus of emails.

Topic models can thus be used to reveal hidden structure in document collections. For example the first topic listed in Table 1 contains words that related to internet security, the second topic relates to new release of productX, and the third topic relates to management issues.

TABLE 1
Topic Lists from analysis of internal emails of
internet security organisation

| | Measure | | Measure | | Measure |
|---|---|---|---|---|---|
| | of | | of | | of |
| | Associ- | | Associ- | | Associ- |
| Topic List | ation | Topic List | ation | Topic List | ation |
| Security | 0.3 | Release | 0.45 | Budget | 0.3 |
| Malware | 0.25 | ProductX | 0.3 | Management | 0.25 |
| Online | 0.2 | Upgrade | 0.25 | OH&S | 0.2 |
| Hacker | 0.15 | Research | 0.12 | Reporting | 0.1 |
| Infected | 0.1 | Develop- | 0.11 | | |
| | | ment | | | |

However in the case of large collections of documents and multiple topics simply obtaining a list of K topics, and a set of words associated with each topic is not particularly informative, particularly in the case of a large collection of documents where they may be many tens or hundreds of identifiable topics present. Further in many cases different subsets of documents will tend to discuss the same sets of topics, and thus the topics may in fact be related and form common themes. However evidence of such further theme structure is not easily discernible from the output of a topic model without extensive analysis. Further visualisation of the results of a topic models have generally used simple Euler Set based visual representations or cluster based visual representations which fail to adequately display large numbers of topics in a logical and meaningful way. Often no simple Euler Set based representation is possible or information is replicated in order to allow display of complex relationships such that visualisation or interpretation alone is still difficult.

Based on this realisation of additional structure, and problems with prior approaches a method for identifying and visualizing topics and themes in a collection of documents has been developed. The method assumes that in addition to a collection of documents being described or summarised by a set of topics, the topics themselves can be further described or summarised by a set of themes which identify sets of related topics. These topics and themes can then be visualised using a visualisation engine that presents the topic and themes with complex and precise boundaries that accurately reflect inclusion and exclusion of themes and topics. Further by linking the semantic analysis and visualisation engines, the results of the semantic analysis can be displayed in an interactive map which accurately summaries the relationships and allows the user to drill down into the topics and themes. Further the user can iteratively refine and improve the results by viewing the output of a particular set of inputs, adjusting these input parameters (such as number of topics and prior probabilities or weights) and then rerunning and visualising the output of the topic models to provide an improved summary of the corpus.

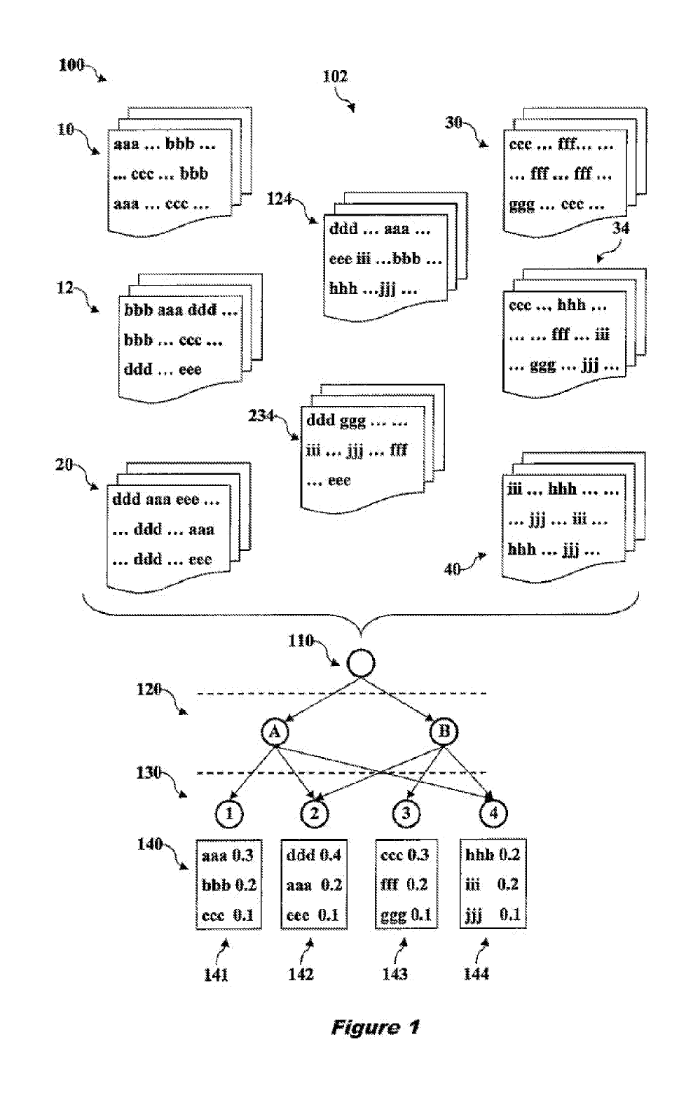

FIG. 1 illustrates a schematic diagram 100 of a collection of documents 102, the words in the documents and the underlying topic and themes structure present in the documents. The collection could be obtained from a variety of sources. For example these may be the emails generated within a corporation, by a security agency, or set of web pages, a collection of conference papers, product documentation, etc. The collection of documents (10, 12, 20, 30, 34, 40, 124 and 234) contains a vocabulary of words (e.g. aaa, bbb, ccc, ddd, eee, fff, ggg, hhh, iii, jjj, etc). Different documents contain different combinations of words, and the same words may occur in multiple documents but are typically present at different frequencies in the different documents. Typically when fitting a topic model the vocabulary is modified to remove stop words which may include common words such as “the”, “and”, etc, or words commonly used in relation to the specific collection of documents (e.g. an organisation name in the case the collection is a set of emails from an organisation or technical names).

As discussed topic modelling is based upon the assumption that an underlying structure of topics exists and that the words in the topics generate the observed words in the documents, and thus by fitting a topic model to a collection of documents an estimate of the topics and the associated words (and their measure of association) may be obtained. For example in FIG. 1, document 10 is generated by the words in topic 1, document 20 is generated by the words in topic 2, and document 12 is generated by the words in topics1 and 2. Similarly documents 30, 40, 34, 124, 234 are generated by words in topics 3, 4, (3 and 4), (1, 2 and 4) and (2, 3 and 4) respectively.

More generally the entire collection of documents may be divided into different subsets with the documents in each sub set being generated by a common set of words which are associated with one or more topics. For example in FIG. 1 a subset of documents (from the total set of all documents in the collection 102) are illustrated behind document 10, each of which contain words from topic 1. Similarly another subset of documents are illustrated behind document 12 each of which contain words from topics 1 and 2, a subset of documents are illustrated behind document 20 each of which contain words from topic 2, etc. Further, for a given subset of documents the different documents in the subset will each sample the words in the associated topic (or topics) with different frequencies For example in FIG. 1 document 10 has words aaa, bbb and ccc from topic 1 with equal frequencies whereas another document in the same subset may have a high frequency of words aaa and bbb, but few instances of ccc, where as another document may have a high frequency of bbb and comparatively lower frequencies of aaa and ccc.

As discussed above a further level of structure referred to as themes may exist, and may be estimated by fitting a second topic model to the collection of documents taking into account the results of the first topic model. The proposed underlying structure is illustrated at the bottom of FIG. 1 in the form of a Directed Acyclic Graph (DAG). The root node of the DAG 110 represents the entire collection of documents 102, also referred to a corpus. The first level of structure is a set of themes 120 labelled A and B each of which have an associated set of topics 130 labelled 1 2 3 4 (indicated by arrows in FIG. 1). Each of the topics comprises a list of words 140 with some degree of association with the topic (typically varying on a word by word basis). For example each list 141 142 143 and 144 contains words associated with each of the topics labelled 1 2 3 4 and their measure of association. For example aaa has measure of word association of 0.3 with topic 1 and 0.2 with topic 2, bbb has a measure of word association of 0.2 with topic 1, and ccc has a measure of word association of 0.1 with topic 1 and 0.3 with topic 3. The topics and theme may be represented as {A→{1, 2, 4}, B→{2, 3, 4}; 1→(aaa, bbb, ccc), 2→(ddd, aaa, eee), 3→(ccc, fff, ggg), 4→(hhh, iii, jjj)}. It is noted that the words (terms) in the topics are non exclusive and the topics in the themes are also non exclusive. That is the same word may appear in multiple topic lists (e.g. aaa occurs in topics 1 and 2 and documents 10, 12, 20 and 124. Similarly ccc occurs in topics 1 and 3 and in documents 10, 12, 30, and 34. Further the same topics may occur in multiple themes (e.g. topics 2 and 4 both occur in themes A and B).

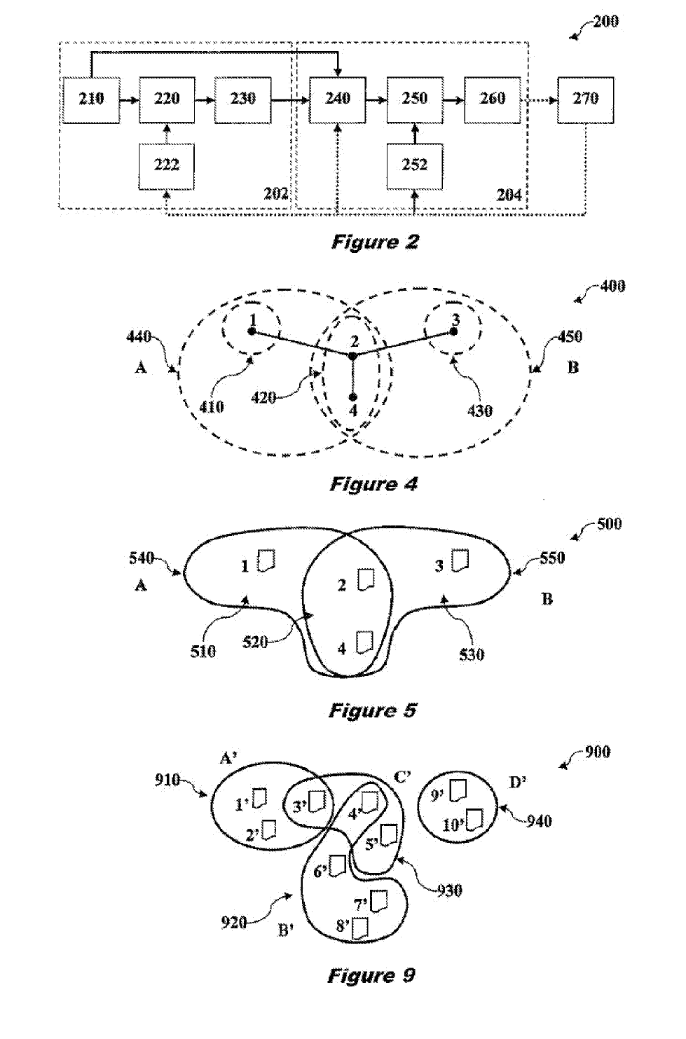

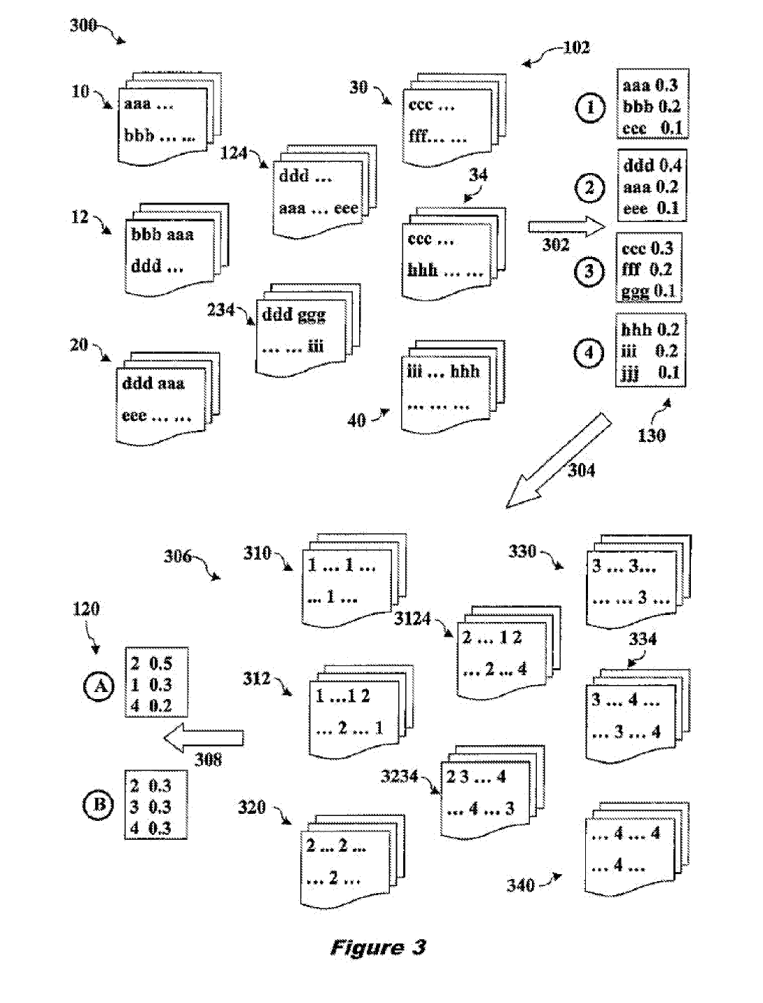

The themes can be estimated by performing two rounds of topic modelling, the first round to identify the set of topics associated with the documents, and the second round to identify the themes based upon the topics associated with the documents identified by the first topic model. FIG. 2 illustrates a flow chart 200 of the estimation method and FIG. 3 is a schematic diagram 300 of the application of the estimation method to the dataset shown in FIG. 1.

A first round 202 of topic modelling is performed in which a first topic model 220 is fitted to (i.e. analyses) a collection of documents 210, based upon a set of (predefined) inputs 222 to obtain (i.e. estimate/generate) a first set of outputs 230. This is further illustrated in FIG. 3, in which an LDA topic model 302 is fitted or applied to the collection of documents 102 having a vocabulary of words (aaa, bbb, ccc, ddd, eee, fff, ggg, hhh, iii, jjj, . . . ). The topic model identifies 4 topics with topic lists limited to the three most associated words for each of the 4 topics. Outputs 130 of the LDA topic model are topic identifiers 1, 2, 3, 4, topic lists including measures of word association {1→(aaa 0.3, bbb 0.2, ccc 0.1), 2→(ddd 0.4, aaa 0.2, eee 0.1), 3→(ccc 0.3, fff 0.2, ggg 0.1), 4→(hhh 0.2, iii 0.2, jjj 0.1)}, and measures of document association (not shown).

Referring to FIG. 2, a second round 204 of topic modelling is performed. The collection of documents 210 is modified based on the outputs 230 of the first round of topic modelling by replacing the words in each document with topic identifiers based upon the measure of document association obtained from the first topic model to obtain a modified collection of documents 240. A second topic model 250 is then applied to the modified collection of documents 240 using a second set of (predefined) inputs 252 to obtain a second set of outputs 260. The outputs 260 are typically the identified themes including a theme identifier, the measures of association of the topics in the theme lists, and the measures of topic association of the topics with the themes.

This is further illustrated in FIG. 3, in which the documents are modified 304 (step 240 of FIG. 2) to obtain the modified set of documents 306. A second LDA topic model 308 is fitted or applied to the modified collection of documents to obtain two themes each with a maximum of three topics per theme. Outputs 120 of the second LDA topic model 308 are theme identifiers A, and B, and theme lists and measures of topic association {A→(1 0.5, 2 0.3, 4 0.2), B→(2 0.3, 3 0.3, 4 0.3)}. Again measures of document association are not shown.

In the embodiment shown in FIG. 3, the modified collection of documents 306 is obtained by replacing the words in the document with the topic identifiers. That is all the words not in a topic list are removed from the documents and each instance of word in a topic list is replaced with the topic identifier(s) of the topic(s) the word is associated with. For example in FIG. 3, document 10 is modified to document 310 by replacing all instances of “aaa” and “bbb” with topic identifier“1”. Document 12 is modified to document 312 by replacing instances of “aaa” with 1 2, instances of “bbb” and “ccc” with “1” and instances of “ddd” and “eee” with 2. Similar modifications are applied to documents 20, 30, 24, 40, 124, and 234 to obtain modified documents 320, 330, 324, 340, 3124, and 3234 and a modified collection of documents 306.

In an alternative embodiment the modified collection of documents 306 is obtained by replacement of the words in a document with topic identifiers based the measures of association of the word with the topic. In other embodiments a sampling or probabilistic based approach may be used, in which topic identifiers are sampled based upon the relative measures of association of the topics with the document. For example is a topic has a larger measure of association with topic 2 compared to topic 1, the relative strength could be used to select the number of topic identifiers (e.g. for a 3:1 ratio, the modified document could comprise 75 instances of “1” and 25 instances of “2”).

In another embodiment the words in a document could be replaced with words from the topic lists, with the replacement words selected using the measures of association and the measures of document association. For example if the three words in topic 1 in a topic list have measures of association with a topic of 0.3, 0.2 and 0.1, then a modified document may comprise 3 instances of the first word, 2 instances of the second word and 1 instance of the third word. Random number based sampling may be used based on these measures of association such as selecting a random number between 0 and 0.6, and if the number is between 0 and 0.3 then select the first word, greater than 0.3 and less than or equal to 0.5 then select the second word and greater than 0.5 then select the last word.

The second round of topic modelling will identify themes comprising words only the topic lists obtained from the first round of topic modelling. These words can then be remapped to the topic identifiers so that the theme comprises identifiers rather than words. The measures of association will also need to be adjusted so they reflect the measure of association of the topic to the theme. This may be done by summing the measures of association of each instance of the topic identifiers. In cases where a word is associated with several topics, the word may be replaced with identifiers for the several topics with the measure of association of the word multiplied with the measure of document association for the topic. The theme identifier may be an arbitrary identifier such as a letter or number, or it may be based upon the topic identifiers of the associated topics.

The results of the topic modelling (topics and themes) may then be visually displayed to a user using a user interface 270. Each of the topics is represented by a topic identifier and each theme is represented by a theme border which encloses the representations of the topics associated with the theme to allow clear identification of which topics are associated with which themes. The topic representations and theme borders are then visually represented to a user. This may be via a user interface such as the user interface 712 shown in FIG. 7. The user interface also allows the user to view and interact with the output such as by allowing them to zoom in (or drill down) into various themes and topics (and out again), as well as extract topics, themes and associated information. An interactive user interface allows a user to focus in on specific areas, such as specific theme or topic which they consider are of interest or warrant further investigation or refinement. An interactive user interface allows them to further adjust or modify the inputs and force reapplication or refitting of the topic models to the complete dataset (i.e. fitting using the modified inputs) or perform fitting on a subset of the dataset (possibly using some of the output information as a starting point) and redisplay of the output based upon the adjusted input parameters.

Strictly fitting a topic model involves assuming a certain topic model and then attempting to estimate the parameters of that model that maximise the marginal log likelihood of the data. Generally as estimation of the optimal parameter is intractable for most topic models, an approximate inference process is used such as variational Expectation Maximisation (EM), expectation propagation, or Markov Chain Monte Carlo approaches such as Gibbs Sampling. Such processes iteratively search for estimates of the parameters which maximise the log likelihood. These are thus the best fit parameters, which due to the complexities of the problem are not guaranteed to be the globally optimum parameters.

The inputs comprise the number of topics (or themes for the second round) K to identify, prior probabilities (or a prior distribution) for the association of words with topics and documents with topics (or topics with themes and documents with themes), a set of stop words, and thresholds such as the maximum terms per topic (theme) or minimum measures of association so that only the most associated words (topics) or topics (themes) are associated with topics (themes) and documents respectively. The exact combination of inputs required will depend upon the model selected, inference method, and other implementation specific details or choices (e.g. memory available, speed/complexity tradeoffs, and level of user control). These inputs may be predefined or predetermined prior to application of the topic model and may be based upon default values (e.g. 20 topics with 10 words per topic), or may be predefined based upon user inputs, such as received from a user interface or from a configuration file or other source. Typically the implementation of the topic model will define default values for the inputs if they are not defined. Additionally or alternatively inputs such as the number of topics K may be based upon prior experience or prior knowledge regarding the collection of documents such as the type, size and structure of documents (e.g. technical/reports/comments, short/long, articles/webpages/emails etc) and/or the number of documents. In some instances an iterative approach could be used in which LDA is run or fitted multiple times with different values of inputs (e.g. K), with the final value of being based upon one or more selection or quality criteria (e.g. a goodness of fit or similar quality criteria returned by the topic model or otherwise estimated).

The output of a topic model such as LDA is a set of topics (themes) comprising a set of words (topics) and associated weights which measure the degree of association of the words with the topic (see FIGS. 1 and 3 and Table 1 above). These weights may simply be the probabilities of association of the word with the topic produced by the topic model or the weight may be some measure based upon these probabilities. For example words which have a high frequency in multiple topics may have their probabilities down-weighted so as to identify words which are more specifically (or uniquely) associated with the topic. Strictly, as each word is assigned a probability of association with a topic the set of words associated with a topic may equal the number of words in the corpus. However as a weighting is associated with each words the complete set of words can be ranked and a cut-off limit is typically applied to identify the most closely associated words. For example the set of words associated with a topic may be limited to the top T words (e.g. top 10 or top 50), or a weight based threshold may be applied (e.g. weight/probability >0.05) so that only the most closely associated words are retained, in which case different topics will typically have different numbers of words associated with them. Topic models such as LDA also output measures of topic association of the topics with the documents. These may be weighted or adjusted in a similar manner to the case of words in topics. Each topic can be given a topic identifier or topic label. This maybe an arbitrary identifier such as a number or it may be based upon the topic list, such as the word with the largest weight or measure of association or a combination of the words with the largest weights or measures of association (i.e. is/are most closely or uniquely associated with the topic).

The preferred topic model fitted is LDA. Implementation of LDA using a Gibbs Sampling based approach is described in detail in Gregor Heinrich, “Parameter estimation for text analysis”, Technical Report, Fruanhofer, IGD, 15 Sep. 2009 (available at: http://arbylon.net/publications/text-est2.pdf) the entire contents of which is hereby incorporate by reference. A Java based implementation of LDA using the LingPipe text processing toolkit (http://alias-i.com/lingpipe/index.html) was developed. Typical default parameters for applying LDA is 50 topics per corpus with uniform topic prior probabilities set to 0.1 and uniform word prior probabilities set to 0.01, burn in period of 0, sampling lag of 1, and 200 samples for the sampling phase.

Thus after running the two rounds of LDA a first set of topics and a second higher level set of themes is obtained which preferably need to be visualised. However effective visualisation of the topics and themes represents a further problem. Simply displaying a list of themes, topics and words is not typically informative, particularly when there are a large number of topics and words per topic. Further given that multiple words may be closely associated with multiple topics, and multiple topics may be closely associated with multiple themes, producing an informative display for both topics and themes is not straight forward. Simple Euler set based or cluster based visual representations (visualisation) also fail to adequately display large numbers of topics in a logical and meaningful way. Often no simple Euler (set based) representation is possible or information is replicated in order to allow displaying of complex relationships such that interpretation is still difficult. Cluster based approaches typically fail to clearly define the boundaries between topics and themes. Further as the purpose is typically exploratory in nature (what topics are being discussed and how are they related) it is preferable that the user can interact with the display to zoom in and out as well as control the number of topics and themes to find, which may required rerunning or refitting of one Or both rounds of LDA.

To overcome these problems a visualisation method for displaying the topics and themes has been developed which provides complex and precise boundaries for topics and themes. These can then be visually represented in an interactive user interface which allow the user to explore and further interpret the results.

The starting point of the visualisation method is set of themes with a list of associated topics, or at least a test or threshold that may be used to obtain such a list (e.g. top 10 topics per theme based on measure of theme association or all topics with measures of theme association greater than 0.1). A set of zones is then defined based upon breaking the themes up into non overlapping intersection sets of topics. That is each zone represents a distinct subset of one or more themes which contain the same set of topics. Thus with reference to FIGS. 1 and 3, there are three distinct sub sets, with zone 1; corresponding to topic 1 in theme A, zone 2 corresponding to topics 2 and 4 which are both associated with themes A and B, and zone 3 corresponds to topic 3, which is only associated with theme B.

Each zone is then provided with a zone location or point in a (2D) layout plane (which may also be referred to as a canvas or a viewing space) and a zone border. The zone locations may be determined by creating an intersection graph of the zones in the layout plane, where the topics are the nodes in the graph and nodes in the same theme are linked. The intersection graph can then form a skeleton around which the zone borders can be drawn. This is further illustrated in FIG. 4 which is a schematic diagram 400 of the application of the visualisation method applied to the results of the topic modelling illustrated in FIGS. 1 and 3. An intersection graph 402 is created using topics 1 2 3 4 as the nodes. Topics 2 and 4 are both common to zone 2 so these are first linked. Next topic 1 is linked to topic 2 and topic 3 is linked to topic 2. When linking topics, small distances (links) may be used for topics in the same zone with larger distances used for linking topics in different zones as is illustrated in FIG. 4. Further the distance between nodes could be adjusted based on the largest measure of association the topic has with any theme. That is topics with large measures of association (irrespective of the theme) may be more distant from topics with small measures of association.

Zone borders 410, 420 and 430 are then drawn around the separate nodes 1, 2 and 4, and 3 (respectively) which correspond to zones 1, 2 and 3. These are drawn so that the border encompasses all the nodes (topics) in the zone, and so there is no overlap between zones (so they an intersection set). The zone borders are preferably using regular shapes such as circles, squares, hexagons or ellipse which are centred on the node or nodes in the zone. However irregular or complex shapes may be used and could be built up from merging a series of regular shapes. For example a circle could be placed around each node in the intersection graph and then circles in the same zone could be joined up to form a single zone border. The size of the border can be based upon the intersection graph, as this will define the distance between two nodes which are in different zones. Thus if the distance is 1 unit a circle of radius 0.4 units could be placed around each node.

Theme borders are then defined or created for each theme based upon or starting from the zone borders of the zones associated with the respective themes. As the zones are non overlapping intersection sets, using these as a starting point allows theme borders to be drawn which will enclose all of the associated topics whilst still providing clear separation between different themes. In the simple case illustrated in FIG. 4, elliptical theme borders 440 and 450 can be chosen for themes A and B. In this embodiment the height and curvature of the ellipse 440 spans the 2nd zone border 420 and also encloses the circular zone 410 for topic 1 so that all the topics associated with topic A are contained within the theme border (defined by ellipse 440). Ellipse 450 for theme B is calculated similarly but encloses circular zone 430 for topic 3 (rather than zone 410).

However using such simple shapes can occupy considerable space (which may not always be readily available) and a more compact approach can be obtained by starting with the zone borders and then joining or merging the borders of adjacent zones. FIG. 5 is a representation 500 of the zone merging technique applied to the same data shown in FIG. 4. Thus new theme border 540 for theme A has been obtained by merging zone 410 with zone 420 by deleting the adjoining or overlapping portion of zone borders 410 and 420 and joining the free edges. Similarly new theme border 550 for theme B has been obtained by merging zone 420 with zone 430 by deleting the adjoining or overlapping portion of zone borders 420 and 450 and joining the free edges. Theme borders may be further adjusted to minimise their area or to smooth boundaries.

Once theme borders have been created a representation of each theme border and each topic within the zone border of the associated zone is displayed. Theme border 540 for theme A contain a topic identifier 510 for topic 1 (from zone 1) and topic identifiers 520 for topics 2 and 4 520 (from zone 2). Similarly theme border 550 for theme B contain a topic identifier 530 for topic 3 (from zone 3) and topic identifiers 520 for topics 2 and 4 520 (from zone 2). A representation (icon) of the topic list is also displayed next to the topic identifier. Hovering a mouse over the icon, clicking on the icon, or zooming in allows a user to view the words associated with the topic and further details such as the measures of association or documents associated with the topic.

The steps of associating a zone location and zone border and subsequent creation of theme borders in the 2D plane (the layout plane) may be implemented using an algorithm for auto generation of Euler diagrams described in Simonetto, P., Auber, D. and Archambault, D. (2009), Fully Automatic Visualisation of Overlapping Sets. Computer Graphics Forum, 28: 967-974 (also submitted to Eurographics/IEEE-VGTC Symposium on Visualization 2009 Ed: H.-C. Hege, I. Hotz, and T. Munzner), the entire contents of which is hereby incorporated by reference. This method produces Euler-like diagrams and can disconnect regions or introduce holes in order to avoid instances of undrawable sets and effectively uses the available space.

The algorithm first builds an intersection graph which represents the structure of the Euler diagram. Each node of the graph represents a zone and an edge links two nodes if their zones are adjacent. The graph is then adjusted using force directed algorithms to avoid any crossings and to make the graph as regular as possible avoiding any large variations in edge length or angular resolution, and the planar graph is drawn. Finally theme boundaries are placed around the nodes in the same theme. Zone boundaries are obtained by building a grid graph around each node which encloses each node and defines non overlapping regions around the node. This is obtained by placing a circle with a common radius (chosen to be just small enough to avoid overlaps) at each node and then inscribing a polygon within the circle. The adjacent edges are joined to form zone borders, and may be smoothed. The topics identifiers are then placed within the zone border. Finally a border joining the zones forming a theme is then drawn. Different themes can be assigned different colours and textures to increase visual awareness of theme boundaries and the different intersection regions within overlapping themes.

In one embodiment the theme borders are determined using a force based layout approach. In this embodiment a topic identifier and a topic representation is associated with each topic. The topic identifier is selected to be the word with the largest weight and topic representation is selected to be a regular geometric shape such as a circle with the area of the representation being based on the largest weight (e.g. for a circle the radius would be based on this weight). As previously described the topics are then divided into zones. The zones (and topics) are distributed using polar coordinates in a plane (or viewing space). Each theme is assigned a theme angle (e.g. 360/N for N themes) and the angle for a zone is based on averaging the theme angle of the associated themes. The zones are then assigned a radial distance from the origin based upon the number of associated themes, with zones with the greatest number of themes placed closest to the origin and zones with the fewest themes placed at greater radial distances. For example if there the maximum number of common themes is T, and the i^{th} zone has Tᵢ themes, then the radial distance is (T−Tᵢ).

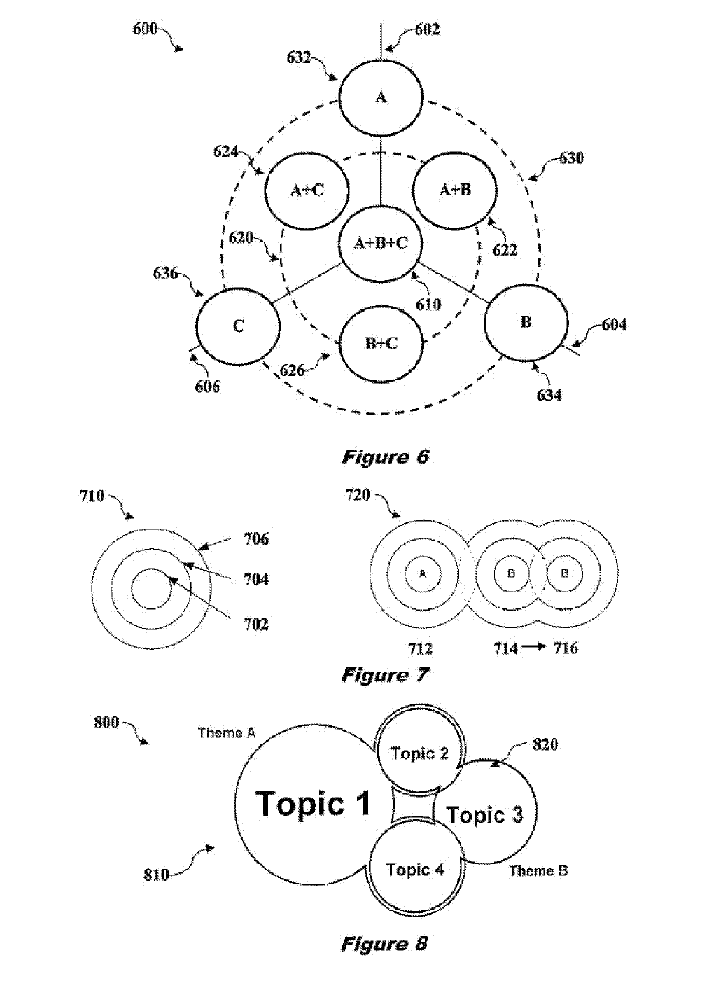

This is illustrated in FIG. 6 in which themes A Band C are assigned theme angles of 0°, 120° and 240° respectively, at which radii 602, 604 and 606 are drawn. For three zones A, Band C, there are 6 distinct sets, namely A+B+C, A+B, A+C, B+C, A, B and C represented by circles 610, 622, 624, 626, 632,634 and 636 in FIG. 6. These six zones are assigned zone angles of 0°, 60°, 120°, 180°, 0°, 120° and 240° respectively based on averaging of theme angles. Zone 610 is located at the origin, zones 622, 624 and 626 are each located at a radial distance of 1 unit, and zones 632, 634 and 636 are each located at a radial distance of 2 units. Dashed circles 620 and 630 have radii of 1 unit and 2 units respectively. For clarity the zones in this example are represented by circles having the same radius, however as discussed above they will each have different areas based on the word with the largest association or weight in the topic.

The zone borders then need to be determined by joining the topic borders of the topics in the same zone. The topic with the largest area is placed at the zone location and with the topics border defining the initial zone border. The topics in a zone are then distributed around the first topic placed and any collisions between topics are resolved using a force directed (or physics based) approach. This is performed by assigning a core and an inner collision radius to each topic. The size of the core and a collision radius may be determined based on the measure of theme association of the topics with the themes forming the zones. A collision occurs if the core of a topic in a zone overlaps with the collision radius of another topic in the zone. A collision can also occur between topics in different zones. Such interzone collisions occur when the topic border of one topic overlaps with the collision radius of another topic in a different zone (i.e. topics in adjacent zones are forced to be further away than topics within the zone). Collisions are resolved by applying an impulse force to separate colliding topics so that they move away from each other. Friction can be applied, momentum assigned based on topic size, and an attraction force may be used to ensure that topics attempt to move towards the origin of their zone. Once an impulse is applied the topics are rechecked for any remaining collisions which are then resolved.

FIG. 7 illustrates a representation of a topic 710 with a core 702, a collision radius 704 and a topic border 706 and an interzone collision 720 between topic A located at position 712 and topic B located at position 714. The topic border of topic B overlaps with the collision radius of topic A and thus an impulse is applied to topic B to move it from initial position 714 to new position 716 which resolves the collision.

Determining if an overlap occurs between topics can be performed vectorially. A first vector is directed from the location of the first topic to the location of the second topic, and assigned a length based on the largest measure of association in the set of words associated with the first topic and the number of shared themes between the first and second topics. A second vector is directed from the location of the second topic to the location of the first topic and has a length based on the largest 10 measure of association in the set of words associated with the second topic and the number of shared themes between the first and second topics. An overlap is resolved by adjusting the location of at least one of the topics so that the first and second vectors no longer overlap.

Theme borders are created or constructed by joining the borders of the topic representations of the topics forming the theme (i.e. constructive geometry). FIG. 8 illustrates an example of the construction of themes 800 by joining topics borders. Topics 1, 2, 3 and 4 have been placed in a viewing plain and with topic identifiers “Topic 1”, “Topic 2”, “Topic 3” and “Topic 4” located at the centre of the topic and the topic border being based upon the word with the largest measure of association in the topic list. In this embodiment Topic 1 has the largest area, followed by topic 3 with topics 2 and 4 of equal (and smaller) size. Theme borders are formed by joining topic borders with Theme A formed from joining the edges of topics 1, 2 and 4, and Theme B formed from joining the edges of topics 2, 3 and 4. Further where a topic shares multiple themes the borders of the different themes are linearly offset.

In further embodiments, the visual representation could be a 3D representation based upon a 2D layout plane. This could be performed by modifying the steps of associating a zone location and a zone border so that a 3D zone border is obtained from the zone border in the layout plane. For example an axis of symmetry, either unitary or piecewise, through the 2D shape could be estimated. The shape could then be rotated about the axis of symmetry to obtain a 3D shape which could then be displayed on a 3D display device. Additionally or alternatively, regular 2D shapes used for zone borders could be replaced with 3D counterparts (e.g. circles with spheres). Creating theme borders (or surfaces) could then be performed by merging the surfaces of the 3D shapes in a manner similar to the merging of borders in 2D. These theme borders (surfaces) could then be displayed by a 3D display device.

A user interface is provided to allow the user to further explore and refine the output of the topic modelling. The user interface includes a display portion, in which visualisation of the topics and themes are presented, an input portion, where the user can input information, and a results portion in which detailed results may be displayed, such as input parameters used and output data. This may be provided as separate windows, tabs, controls, menus etc. Thus once topics are visualised the user can zoom in or out to view the entire set of themes and topics or a portion of the viewing space. Users can click on a topic or theme identifiers, or hover a mouse over the topics or themes to trigger display of further information about the topic or theme, such as the list of words and measure of association, and associated documents. For example clicking on a topic could list the top 10 words associated with the topic.

Many of the input parameters such as the number of topics and themes, thresholds for list sizes, and prior probabilities for generation of topics and themes are arbitrarily chosen or based on past values for similar datasets. As such they may not reflect the optimum set of parameters for the current dataset. Thus after reviewing and exploring the results the user may be interested in modifying the input parameters and forcing refitting of the topic models to observe the effect. In many cases there will be no optimum output, and so an iterative a trial and error approach may be required to allow the user to identify the best, or at least, a preferred output.

Alternatively the user may be interested in a particular subset of the results and may wish to refit topic models over a selected subset of the data, or they may wish to preserve some but not all of the structure such as specific topics or themes. This is achieved by allowing a user to select a desired topics or themes of interest in the user interface, such as using a mouse or other user input to select the displayed topics and themes in the viewing space. To preserve such structure some implementations of topic models allow for manual definition of topics as part of the input. Alternatively the prior probabilities of words in a selected topic can be assigned based upon the current measures of topic association. By starting the model with a good estimate of certain topics and themes this increases the likelihood of preservation of the selected topic. In another embodiment the prior probabilities may be adjusted to try and break up a topic, or exclude certain words from a topic. Alternatively the user may be interested in a particular subset of themes and topics. In this case all documents not related to the desired topics or themes could be discarded and topic modelling performed on the reduced collection of documents.

In another embodiment the second round of topic modelling might be applied or performed on a subset of the collection of documents. For example a user may perform a first round of topic modelling and may inspect the results before proceeding to the second round. Alternatively the use may inspect the results after performing two rounds of topic modelling and wish to preserve the overall topic structure, but may wish to re-estimate the theme structure by selecting a subset of the complete set of documents used to estimate the themes. Alternatively the first round of topic modelling could be performed on a subset of the collection of documents and the second round of topic modelling could be performed on the entire collection of documents. In this case the additional documents in the entire collection of documents (with respect to the subset used to estimate the topics) will lack measures of association with the topics. Various strategies may be used to modify the collection of documents, such as by replacing any instances of words found in topic lists with the topic identifiers, or by performing a heuristic or threshold based assessment of whether a document may be associated with a topic. For example a test could be performed to determine if the document includes at least n occurrences of words in a topic list, in which case an association will be made the words in the document are replaced with the one or more words from the associated topic list.

FIG. 9 is a representation of the output obtained after refitting the model in response to modification of the inputs by a user. In this embodiment the user modifies the inputs to increase the number of topics from 4 to 10 (denoted 1′ . . . 10′) and number of zones from 2 to 4 (A′, B′, C′, D′) having respective theme borders 910, 920, 930 and 6940. Refitting the topic models with these adjusted input parameters reveals finer structural detail, with the area 540 represented by theme A in FIG. 5 now represented by themes A′, B′ and C′ and the area 550 represented by theme B in FIG. 5 now represented by themes B′, C′ and D′. The theme borders 910, 920, 930 and 640 for themes A′, B′, C′ and D′ and more complex and several new zones (intersection regions) are evident compared to the simple representation shown in FIG. 5.

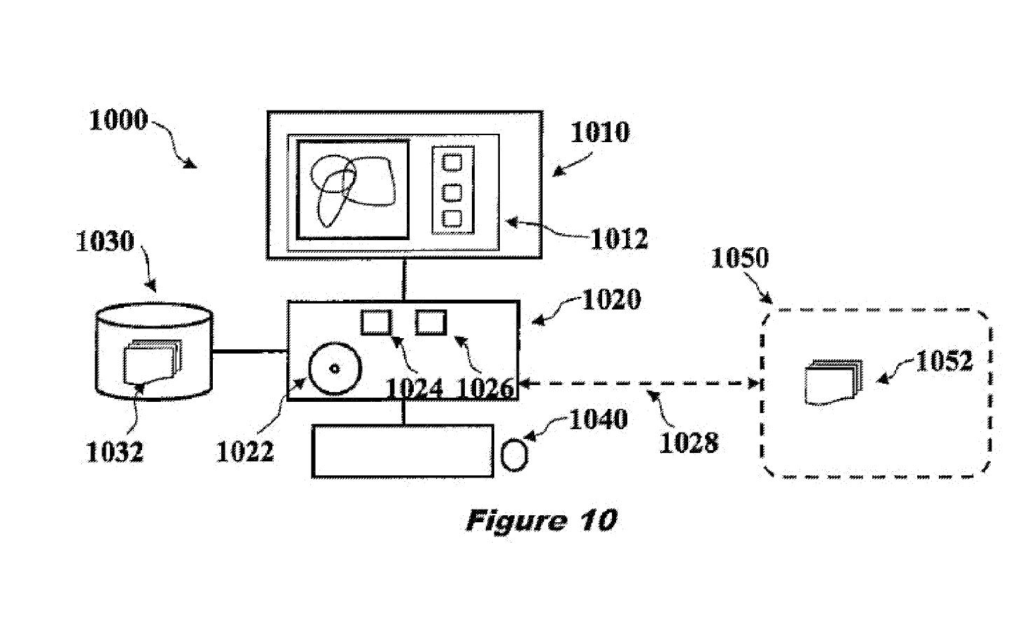

FIG. 10 is representation of a computer system 1000 implementing a method according to an embodiment of the present invention. The computer system includes a display device 1010, a computing device 1020 including a processor 1024 and memory 1026, a storage device 1030 and user input devices 1040. The memory may include RAM, SDRAM, a hard disk, and/or other non transitory storage technologies. A computer readable medium 1022 such as a DVD, portable hard drive or USB drive may be inserted into the computing device or downloaded to the computing device, to provide instructions for the processor to execute a software application 1012. An internet or network connection 1028 may also be provided for access to external information sources 1050, such as collection of documents 1052. Alternatively or additionally a collection of documents may be stored in a local database 1032. The software application may be implemented using any suitable language such as JAVA, C, C++, C#, Python, .Net etc. They system may be implemented as a standard alone system, or use a distributed system including the use of client-server, web based and/or cloud computing based applications which may reduce the computational burden on the local computing device and associated display device.

The methods and system described herein allow users to gain a deeper understanding of document collections through the use of two rounds of topic models to identify both topics and higher level themes in collections of documents. This addition of theme level structure is particularly useful when themes in collections of documents. This addition of theme level structure is particularly useful when large or complex datasets are being analysed as it facilitates identification of logical links between topics that would not otherwise be apparent or may be missed. This may occur when a large number of topics are selected, in which case it is difficult to identify which links are present, or alternatively when a user only specifies or fits a small number of topics to produce a more manageable number of topics for analysis, the underlying structure may be blurred or combined into single topics or across topics which may ultimately hinder the analysis.

The ability of users to obtain a deeper understanding of document collections is further assisted by providing a visualisation user interfaces which clearly defines theme borders to allow clear identification of which topics are associated with which themes, and the overall structure of the document collection. Providing such a user interface facilitates understanding of structure present, as well as whether further adjustment of the model is warranted, such as by adjusting the number of topics and themes, as well as allowing a user to zoom in and drill into to a particular theme or topic (e.g. what words and documents are associated with a theme or topic), or even perform further analysis of a specific theme or themes (e.g. a region of the display). Embodiments of the visualisation user interface allows non technical users to simply apply and refine topic models to datasets and allows them to extract more relevant information from the document collection. Embodiments of the invention thus have wide application to a range of professions such as security professionals, IT managers, marketing or product managers, etc and to a wide range of datasets such as document collections (e.g. contents of a hard disk), discussion groups, website articles, news articles, email collections, etc.

Those of skill in the art would understand that information and signals may be represented using any of a variety of technologies and techniques. For example, data, instructions, commands, information, signals, bits, symbols, and chips may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. Software modules, also known as computer programs, computer codes, or instructions, may contain a number a number of source code or object code segments or instructions, and may reside in any computer readable medium such as a RAM memory, flash memory, ROM memory, EPROM memory, registers, hard disk, a removable disk, a CD-ROM, a DVD-ROM or any other form of computer readable medium. In the alternative, the computer readable medium may be integral to the processor. The processor and the computer readable medium may reside in an ASIC or related device. The software codes may be stored in a memory unit and executed by a processor. The memory unit may be implemented within the processor or external to the processor, in which case it can be communicatively coupled to the processor via various means as is known in the art.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A method for estimating and visualising a plurality of topics in a collection of documents, wherein the collection of documents comprises a plurality of words and each document comprises one or more of the plurality of words, the method comprising:
performing two rounds of topic modelling to the collection of documents, wherein the first round of topic modelling estimates a plurality of topics associated with the collection of documents and each topic comprises one or more words, and the second round identifies a plurality of themes associated with the topics, wherein each theme comprises one or more topics; and
visually representing the topics and themes to a user.

2. The method as claimed in claim 1, wherein in the step of visually representing the topics and themes to a user, each of the topics is represented by a topic identifier and each theme is represented by a theme border which encloses the representations of the topics associated with the theme to allow clear identification of which topics are associated with which themes.

3. The method as claimed in either claim 1 or claim 2, wherein the second round of topic modelling applies a topic model to a modified collection of documents obtained from replacing the words in each document in the collection of documents based upon the one or more topics associated with the collection of documents obtained from applying the first topic model.

4. The method as claimed in claim 3, wherein each topic further comprises a topic identifier and a measure of topic association for each of the one or more words associated with the topic, and the first round of topic modelling also estimates a measure of document association of each topic with each document in the collection of documents, and each theme further comprises a theme identifier, one or more topic identifiers and the second round of topic modelling also estimates a measure of theme association of each of the one or more topic identifiers with the theme, and the second round of topic modelling applies a topic model to a modified collection of documents obtained from replacing the words in each document with one or more topic identifiers each having a measure of document association greater than a predefined threshold.

5. The method as claimed in any one of claims 1 to 4, wherein the first and second topic model is a Latent Dirichlet Allocation (LDA) topic model.

6. The method as claimed in claim 2, wherein visually representing the topics and themes to a user further comprises the steps of:
associating each topic with a zone, where each zone represents a distinct subset of one or more themes;
associating a zone location and zone border in a plane for each of the zones;
creating a theme border for each theme wherein the theme border is based upon the zone borders of the zones associated with the respective theme;
displaying a representation of each theme border and each topic within the zone border of the associated zone.

7. The method as claimed in claim 6, wherein associating a zone border further comprises creating an intersection graph of the zones and determining a zone border based upon nodes in the intersection graph.

8. The method as claimed in either claim 6 or claim 7, wherein a user can interact with the displayed representations so as to adjust model input parameters and force reapplication of the topic models and redisplay of the output based upon the adjusted input parameters.

9. A computer usable medium including instructions for causing a computer to perform any one of the claims 1 to 8.
